(19) United States
(12) Patent Application Publication
(10) Pub. No.: US 2004/0023698 A1
(43) Pub. Date: Feb. 5, 2004

(54) Portable flat charger for a cell phone

(76) Inventor: Ming-Yuh Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/211,560

(22) Filed: Aug. 5, 2002

(51) Int. Cl. H04B 1/38

(52) U.S. Cl. 455/573; 455/572

(57) ABSTRACT

A portable flat charger for a cell phone has a flat cell employed as the energy source, and a connector, which has a particular specification to correspond to a charging port of the cell phone, has two electrical wires to respectively connect with a cathode and an anode of the flat cell. A resistor and a diode connected in series are further provided between the anode of the flat cell and the connector, wherein the resistor is used to control the charging current intensity, and the diode is applied to prevent a backflow current from the cell phone to the flat battery when the cell phone is completely charged.

### BACKGROUND OF THE INVENTION

1. Field of Invention

The present invention relates to a portable flat charger for a cell phone, and more particularly to a flat charger employed with a flat cell that has small size and is capable of providing a high current to rapidly charge the cell phone.

2. Related Art

Nowadays, the cell phone is the most widely used communication device for the public because of its advantages of small size and convenience in being able to immediately communicate with other people at any time and any place. However, for a cell phone user, the most troublesome problem is when the power in the cell phone battery has been totally consumed and the user does not have a re-charger handy. To solve the problem, a common solution is that the cell phone user prepares a backup battery to replace the original battery.

Since the dry battery is easy to purchase, another kind of solution employed with a dry battery is applied to a portable cell phone charger as shown in FIG. 4. That figure shows the cell phone charger is mainly composed of a chamber (50) to retain a plurality of dry batteries (51) that are connected in series. A connector base (52) has two wires that are respectively and electrically in connection with a cathode and an anode of the series-connected dry batteries (51). The connector base (52) is formed with a particular specification that corresponds to a charging means of a specific cell phone.

When the cell phone user purchases the dry batteries (51) and fits them into the charger, the dry batteries (51) are able to provide a charge current through the connector base (52) into the battery of the cell phone.

However, the conventional cell phone charger still has some drawbacks which need to be overcome. One problem is the energy capacity of the dry battery is very small, so the charging time is usually quite long. If more dry batteries are used, although the charger can provide a higher current to the cell phone, the entire size of the charger is accordingly enlarged and thus inconvenient to carry. A further problem is that the dry batteries can not be stored for a long time, otherwise the energy of the dry battery will become reduced.

To overcome the shortcomings, a portable flat charger for a cell phone in accordance with the present invention obviates or mitigates the aforementioned drawbacks.

### SUMMARY OF THE INVENTION

The primary objective of the present invention is to provide a portable flat charger that is convenient to carry and capable of fast charging a cell phone via its advantages of small size and high charge current.

To achieve the objective, the portable flat charger comprises:

a flat cell with a cathode electrode and an anode;

a connector with two wires for respective connection with the cathode and the anode of the flat cell, wherein a resistor and a diode are provided to connect in series with the wire that connects to the anode;

wherein the connector is adapted to link with a charging port of a cell phone so as to charge the cell phone.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a portable flat charger for a cell phone in accordance with the present invention;

FIG. 2 is a block diagram of the portable flat charger of FIG. 1 in accordance with the present invention;

FIG. 3 is an operation view showing the portable flat charger of FIG. 1 is applied to charge the cell phone; and

FIG. 4 is a plan view of a conventional portable cell phone charger.

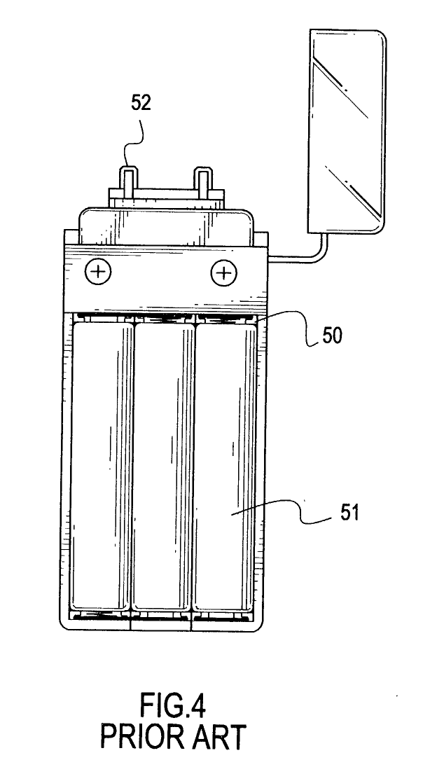

### DETAILED DESCRIPTION OF THE INVENTION

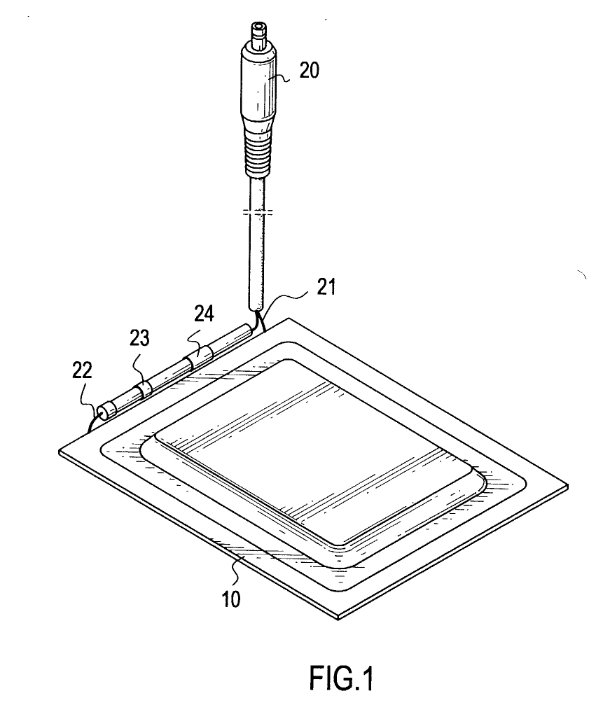

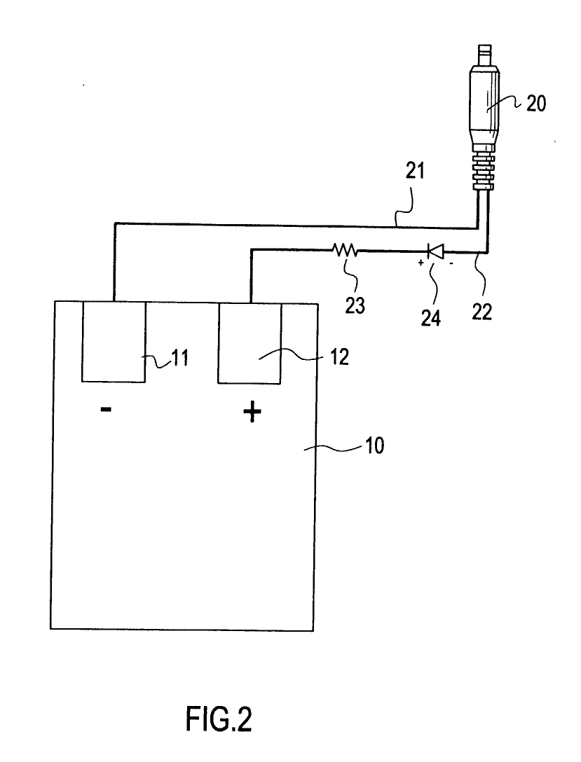

With reference to FIGS. 1 and 2, a portable flat charger for a cell phone in accordance with the present invention comprises a flat cell (10) with a cathode (11) and an anode (12), and a connector (20) with two electrical wires (21, 22) extending therefrom to respectively and securely connect to the cathode (11) and the anode (12). In FIG. 1, both wires (21, 22) are further joined together to form a single cable by an isolating material. As shown in FIG. 2, a resistor (23) and a diode (24) connected in series are further connected with the wire (22), wherein the positive terminal (denoted with +) of the diode (24) is connected to the flat cell (10) through the resistor (23), and the negative terminal (denoted with −) of the diode (24) is connected to the connector (20). The specification of the connector (20) corresponds to the specification of a charging means in a cell phone, i.e. the specification of the connector (20) is variable.

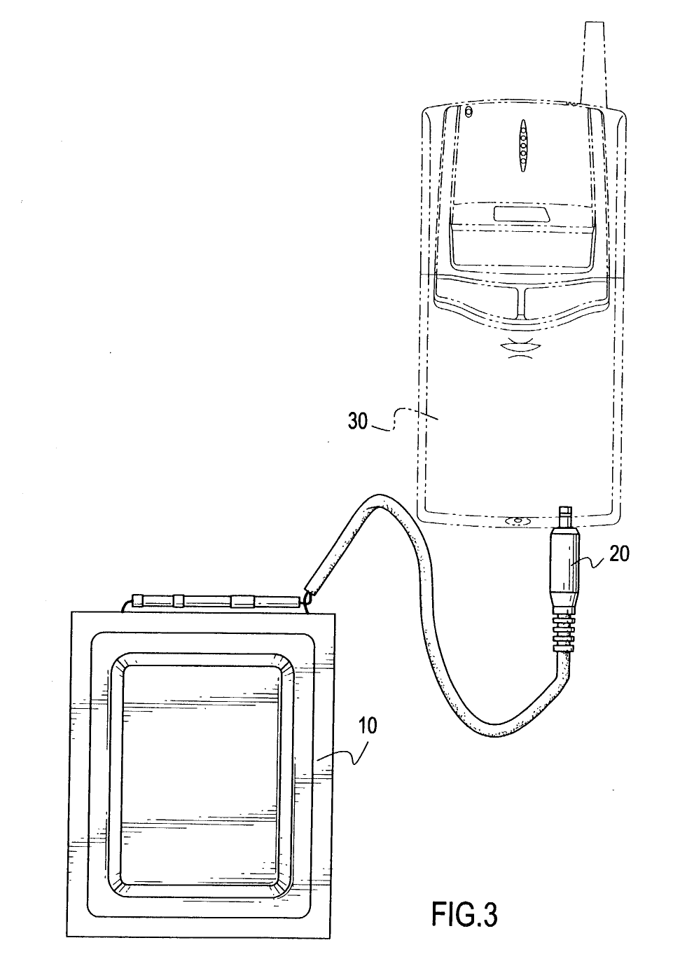

With reference to FIG. 3, when the flat charger of the present invention is applied to a cell phone (30), the connector (20) is electrically linked to a charging port of the cell phone (30). Since a complete charge loop is formed, the flat cell (10) immediately outputs a charge current to the cell phone (30) through the connector (20). The use of the resistor (23) is intended to control the intensity of the charge current flowing into the cell phone (30). The employment of the diode (24) is able to prevent a backflow current that would otherwise flow from the cell phone (30) to the flat cell (10) when the cell phone (30) is completely charged.

By the use of the flat cell (10), the entire size of the charger is greatly minimized so that the charger is very convenient to carry around. Further, since the flat cell (10) and the charging connector (20) are together integrated to a single product, the user does not need to purchase extra dry batteries.

The invention may be varied in many ways by a skilled person in the art. Such variations are not to be regarded as a departure from the spirit and scope of the invention, and all such modifications are intended to be included within the scope of the following claims.

What is claimed is:

1. A portable flat charger for a cell phone, the flat charger comprising:
a flat cell with a cathode and an anode; and
a connector adapted to link to the cell phone and having a first wire and a second wire to respectively and electrically connect to the cathode and the anode of the flat cell, wherein a resistor and a diode are together connected to the second wire in series, so that the resistor and the diode are linked between the anode of the flat cell and the connector;
wherein a specification of the connector is corresponded to a charging port of the cell phone to be charged.

2. The portable flat charger as claimed in claim 1, wherein a positive terminal of the diode is connected to the flat cell through the resistor, and a negative terminal of the diode is connected to the connector.

3. The portable flat charger as claimed in claim 2, wherein the first wire and the second wire are together further enclosed with an isolating material to form a single cable.
